(19) United States
(12) Patent Application Publication
(10) Pub. No.: US 2004/0008104 A1
(43) Pub. Date: Jan. 15, 2004

(54) System and method for providing a synchronization signal

(76) Inventors: David E. Endsley, Tampa, FL (US); Christopher J. Rourk, Dallas, TX (US)

Correspondence Address: Christopher J. Rourk, 4507 Bretton Bay Lane, Dallas, TX, 75287, US

(21) Appl. No.: 10/193,337

(22) Filed: Jul. 12, 2002

(51) Int. Cl. H04B 3/36

(52) U.S. Cl. 340/407.1

(57) ABSTRACT

An apparatus for providing a synchronized timing signal is provided. The apparatus includes a touch-stimulus system that generates a tactile stimulus in response to a driver signal. The apparatus also includes a conversion system that receives a data signal that includes timing data, and which generates a timing signal that is synchronized with the timing data. A driver system is connected to the tactile stimulus system and the conversion system. The driver system receives the timing signal and generates the driver signal, such that the driver signal is synchronized with the timing data.

### FIELD OF THE INVENTION

The present invention relates generally to synchronization devices, and more particularly to a system and method for providing a synchronization signal.

### BACKGROUND

Musicians and other persons frequently have need to receive a synchronization signal to allow them to perform in various circumstances. For example, a musician may require a synchronization signal when performing live, due to the presence of echo or noise that prevents the musician from obtaining a reliable synchronization signal from other musicians. This problem is more acute when several musicians are providing a synchronization signal, such as two or more rhythm instrument musicians, or a rhythm instrument musician that is performing with recorded music, or a rhythm instrument musician that is performing with a synchronized rhythm pattern. Other musicians may also require synchronization signals under these conditions, such as guitar players, violin players, keyboard players, wind instrument players, stringed instrument players, percussion instrument players, or other suitable musicians.

The classes of musicians described above may also require a synchronization signal when performing music in a recording studio. Recording studios typically utilize staged recording sessions to optimize time usage by musicians and recording personnel. Thus, many musicians are required to record individual tracks of music while listening to a recorded tracks of music.

In addition, other activities may require synchronization. Such synchronization signals are usually aural, including but limited to synchronization signals for sporting activities (such as a gunshot to begin a race), manufacturing activities (such as a whistle to start work on a manufacturing piece in a production line), cutting activities (such as a signal to start cutting with a power saw), drilling activities (such as a signal to start drilling with a power drill), hammering activities (such as a signal to strike a target), shooting activities (such as a signal to fire on a target), blasting activities (such as bullhorn to activate explosives), and construction activities (such as a signal to operate power machinery).

Although situations requiring a synchronization signal are known, the only means available for providing the synchronization signal are aural. These audio synchronization signals require the musician or other person to wear a cumbersome and unattractive headset, which may interfere with the ability of the musician or other person to hear other music or other important audio signals. In addition, headsets typically require a cord because of the power requirements of the headset, which results in an additional source of annoyance, aggravation, and distraction.

### SUMMARY OF THE INVENTION

Therefore, a need has arisen for a system and method for providing a synchronization signal that does not require the person receiving the signal to wear a headset or otherwise listen for an audio synchronization signal.

In accordance with the present invention, a system and method for providing a synchronization signal are provided that substantially eliminate or reduce disadvantages and problems associated with previously developed systems and methods for providing a synchronization signal.

One aspect of the present invention is an apparatus for providing a synchronized timing signal. The apparatus includes a touch-stimulus system that generates a tactile stimulus in response to a driver signal. The apparatus also includes a conversion system that receives a data signal that includes timing data, and which generates a timing signal that is synchronized with the timing data. A driver system is connected to the tactile stimulus system and the conversion system. The driver system receives the timing signal and generates the driver signal, such that the driver signal is synchronized with the timing data.

The present invention provides many important technical advantages. One important technical advantage of the present invention is a system for providing a synchronization signal that does not require the person receiving the synchronization signal to hear the synchronization signal. The present invention thus allows a musician to perform in synchronism with recorded or electronic music without having to focus mental resources on distinguishing musical sounds from synchronization signal sounds.

Another important technical advantage of the present invention is a method for providing a synchronization signal that allows a person to receive the synchronization signal in an environment where aural stimuli are not reliable or impractical to provide. The method of the present invention may thus be used to reliably provide timing stimuli in a variety of circumstances.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 is a diagram of a system for providing a synchronization signal to a musician in accordance with teachings of the present invention;

FIG. 2 is a block diagram of a system for providing a synchronization signal to a musician in accordance with teachings of the present invention;

FIG. 3 is a block diagram of an interface system for use in a system for providing a synchronization signal to a musician in accordance with teachings of the present invention; and

FIG. 4 is a flow chart of a method for providing a synchronization signal to a musician in accordance with teachings of the present invention.

### DETAILED DESCRIPTION OF THE DRAWINGS

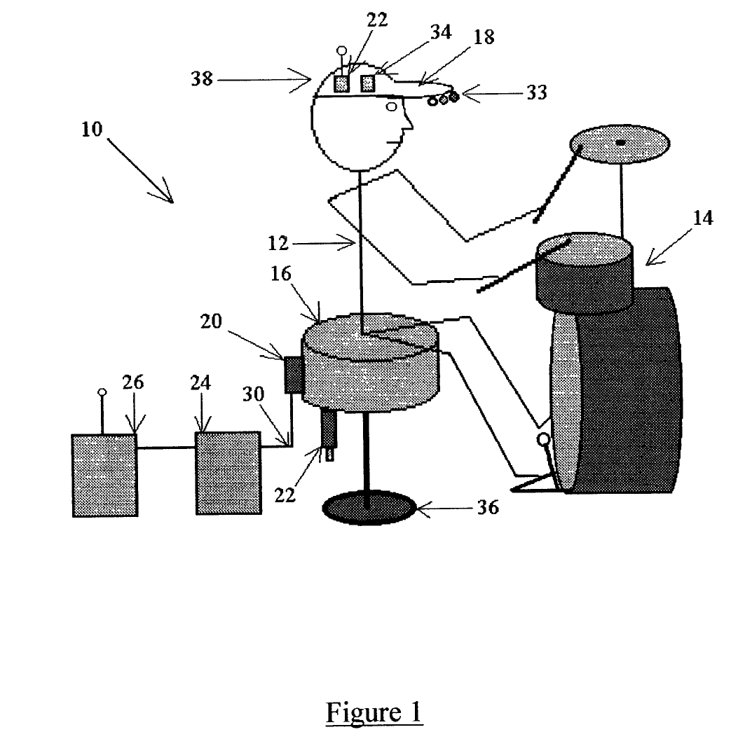

FIG. 1 one shows exemplary rhythm synchronization system 10 embodying concepts of the present invention. Rhythm synchronization system 10 is configured for use by a drummer 12, but may also or alternatively be used with other suitable musicians, including but not limited to conductors, keyboard players, guitar players, stringed instrument players, wind instrument players, and percussion instrument players. Rhythm synchronization system 10 provides drummer 12 with a tactile or visual signal, such that drummer 12 may play rhythm devices 14 in synchronism with the signal.

Rhythm synchronization system 10 includes visual rhythm device 18 and/or tactile rhythm device 16. Tactile rhythm device 16 may include a drum stool, as shown, that has a embodied within the seat one or more tactile driver mechanisms, such as a solenoid driver. Tactile rhythm device 16 further includes wire line driver interface 20 or wireless driver interface 22. Wire line driver interface 20 is coupled to driver/interface 24 via a suitable conductor 30, including but not limited to a copper conductor, a coaxial conductor, or a fiber optic conductor. Alternatively, wireless driver interface 22 may be used to couple tactile rhythm device 16 to driver/interface device 24. In this alternative embodiment, a wireless receiver 26 is coupled to driver/interface device 24.

In addition to tactile rhythm device 16 or alternatively, visual rhythm device 18 may be used by drummer 12 to receive rhythm signals. Visual rhythm device 18 includes one or more light emitting devices 32, which are coupled to driver 34. Driver 34 is coupled to wireless driver interface 22, which is coupled to driver/interface device 24 such as through wireless receiver 26.

In operation, a drummer 12 receives rhythm signals via tactile rhythm device 16 or visual rhythm device 18. For example, drummer 12 may receive tactile pulses through drum stool 34, or may receive light signals through light emitting devices 32 in hat 38. The drummer 12 may then use the rhythm signals to play in synchronism with an external signal or a regulated rhythm signal, thus allowing drummer 12 to be assured of the correct synchronization with other music signals.

When a tactile rhythm device 16 is used, it may be necessary to provide a connection to an external power source, such as an electric or pneumatic power source. This external power source may be required because of the power requirements for producing a tactile signal. One advantage provided by using visual rhythm device 18 is that the lower power requirements for producing a visual signal as compared to a tactile signal allow a portable power source to be provided, such that the musician may use rhythm synchronization system 10 without being constrained by an attached cord. Depending upon the sensitivity of the musician, though, a wireless tactile signal may also be provided, such as by a small solenoid.

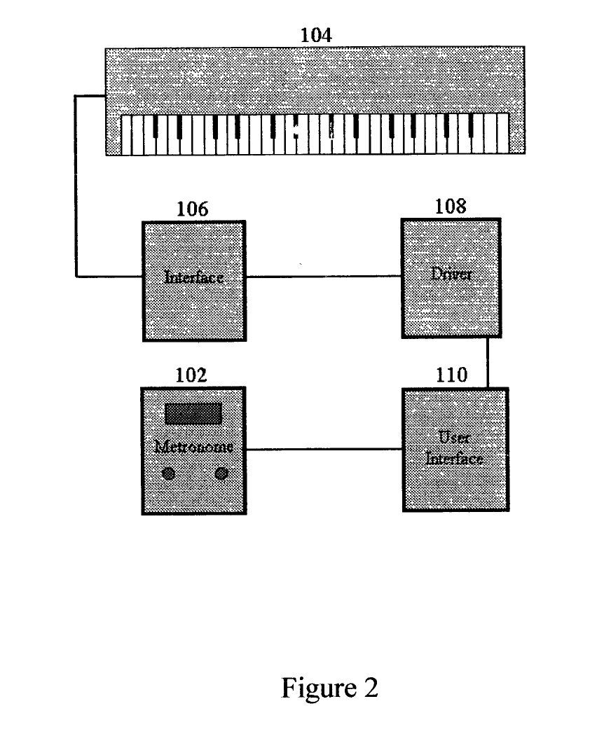

FIG. 2 is a block diagram of a system 100 for providing a rhythm signal to a user in accordance with an embodiment of the present invention. System 100 includes a rhythm signal generating device, such as a metronome 102 or a musical instrument 104. Metronome 102 may be an analog or digital metronome that generates a regulated sound or electrical rhythm pulse, or other suitable rhythm generating devices. Musical device 104 may be a keyboard, a guitar, a rhythm instrument, a musical instrument digital interface compatible instrument, or other suitable devices.

Musical instrument 104 or metronome 102 is coupled to interface 106. Interface 106 is operable to receive the timing signals from the rhythm signal generating device and to convert the timing signals into a form usable by driver 108. Interface 106 may be implemented in hardware, software, or a suitable combination of hardware and software. For example, interface 106 may include a 5550 chip.

Interface 106 is coupled to driver 108. Driver 108 may be implemented in hardware, software, or a suitable combination of hardware and software. Driver 108 may include a solenoid driver, a light emitting device driver, or other suitable devices. For example, driver 108 may include light emitting diodes or other devices capable of generating a tactile or visual pulse stimulus that may be detected by a human being.

Driver 108 is coupled to user interface 110. User interface 110 is a suitable usual interface device, such as tactile rhythm device 16 or visual rhythm device 18 of FIG. 1. User interface 110 is used to provide a rhythm signal to user 12.

In operation, a rhythm signal is received at interface 106 from a rhythm generating device, such as musical instrument 104 or metronome 102. Interface 106 is operable to receive the signals generated by the rhythm generating device and to convert the signals into a signal that is usable by driver 108. Driver 108 produces a stimulus in synchronization with the rhythm signal input from interface 106. This stimulus may include a physical tactile pulse or a visual pulse, such that a drummer would be able to discern the rhythm being generated by a driver 108. The driver 108 delivers the pulse to user interface 110. User interface 110 may include a drum stool with one or more incorporated tactile devices, a vest with one or more incorporated tactile devices, a baseball cap with one or more incorporated visual light emitting devices, or other suitable user interfaces that may be worn or otherwise accessible to a musician such as a drummer while allowing the musician to perform music.

The present invention provides several important technical advantages for providing rhythm signals to a musician. One important technical advantage of the present invention is that the musician may concentrate on the music without having to listen for additional rhythm signals. Instead of requiring the musician to split his or her aural concentration between the music and the timing signal, the musician receives rhythm signals from other sensory input, such as tactile or visual sensory input. This allows the musician to receive dual mode rhythm stimulation, such that increased sensitivity to rhythm signals is obtained and more reliable rhythm signal recognition can be accomplished. Another advantage is that the tactile and visual rhythm devices may be configured to be less intrusive to the drummer than other means of providing rhythm or synchronization signals to a musician.

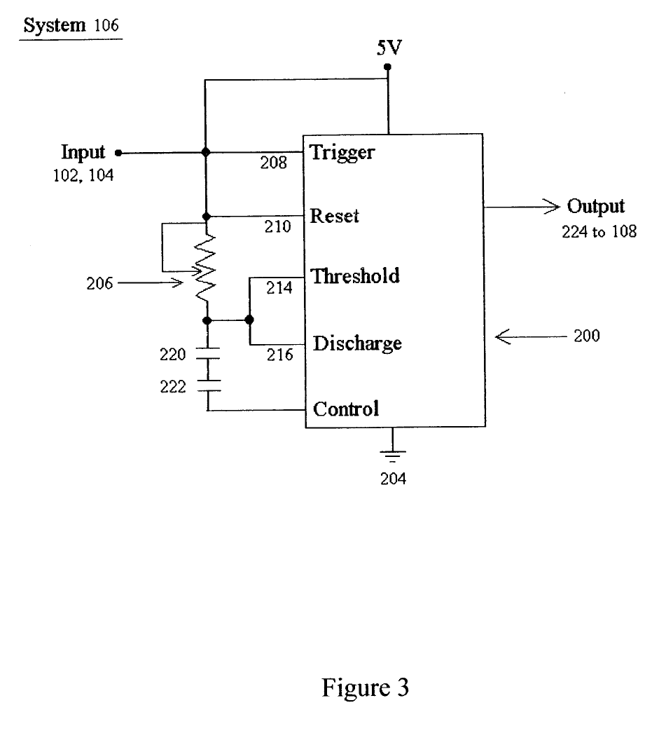

FIG. 3 is a block diagram of an interface system 106 for use in a system for providing a synchronization signal to a musician in accordance with teachings of the present invention. Interface system 106 may be implemented in hardware, software, or a suitable combination of hardware and software.

Interface system 106 includes device 200, which may be a 5505. An input signal from metronome 102 or musical instrument 104 is received at a trigger 208. The trigger is also tied to source voltage 202, such that the input to the trigger 208 is normally high. A potentiometer 206 is coupled from reset 210 to threshold 214 and discharge 216. The resistance value of the potentiometer may be set to increase or decrease the rate at which the voltage at the threshold 216 increases, based upon the resistor-capacitor time constant of potentiometer 206, capacitor 220, and capacitor 222. A reference voltage 204 is applied to the junction of capacitors 220 and 222 in order to tie the input to control 218 to the lower reference voltage 204 after device 200 discharges the energy stored in capacitor 220 through output 224.

In operation, device 220 is used to apply a calibrated timing signal to the driver 108. A resistor-capacitor circuit with a variable resistor is used to control the resistor-capacitor time constant, which regulates the rate at which a signal is applied to driver 108. A user may override this metronome function by applying a signal to trigger 208, such as from an external metronome 102 or musical instrument 104.

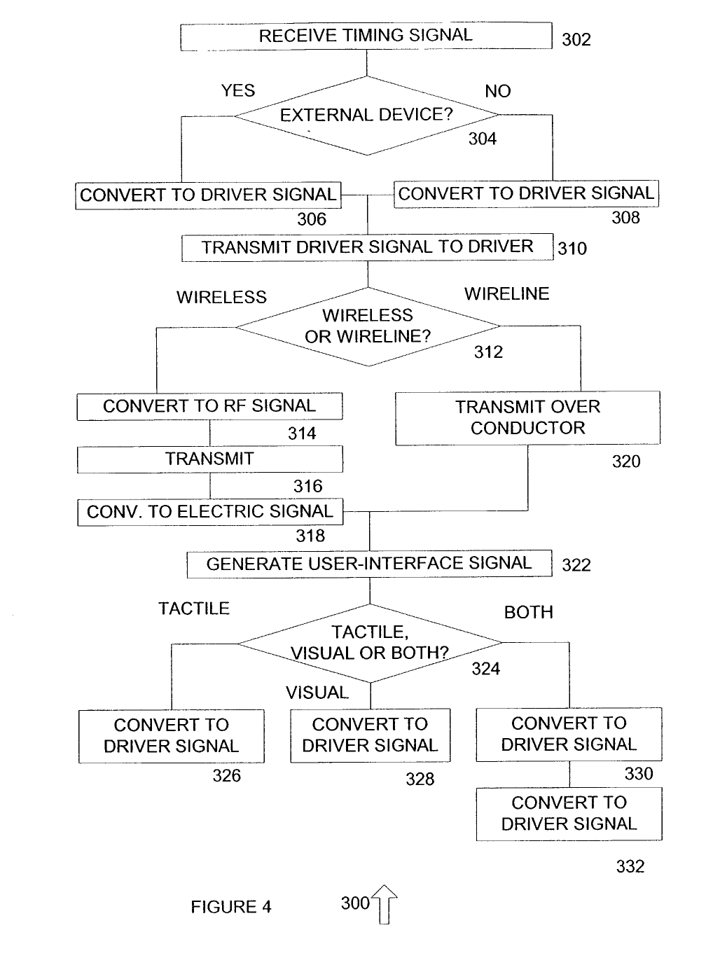

FIG. 4 as a flow chart of a method 300 for providing a synchronization signal to a musician in accordance with teachings of the present invention. Method 300 begins at step 302, where a timing signal is received, such as from a reference device, a musical device, a metronome, an internal device, or other suitable timing signal sources. The method then proceeds to step 304, where it is determined whether the device is an external device.

If the device is an external device, the method proceeds to step 306, where the timing signal is converted to a driver signal. The method then proceeds to step 310. If the device is not an external device, then the method proceeds to step 308 where a driver signal is generated. The method then proceeds to step 310.

At step 310, the driver signal is transmitted to the driver. The method then proceeds to step 312, where it is determined whether the driver signal is a wireless or a wire line signal. If the signal is a wireless signal, the method proceeds to step 314, where the signal is converted to a radio frequency signal. The radio frequency signal is then transmitted at step 316, and the method proceeds to step 318. At step 318, the signal is received at a radio receiver and is converted to an electrical signal. The method then proceeds to step 322, where a user-interface signal is generated, such as by a driver.

If it is determined that the driver signal is a wireline signal at step 312, the method proceeds to step 320 where the driver signal is transmitted over a suitable conductor, such as one or more copper conductors. The method then proceeds to step 322.

Depending upon the driver circuitry and the type of synchronization signal, the method proceeds from step 324 in a predetermined manner. If the signal is a tactile signal, the method proceeds from step 324 to step 326, where one or more tactile pulses are generated. If the signal is a visual signal, then the method proceeds from step 324 to step 328 where one or more light pulses are generated. If the signal includes both tactile signals and visual signals, the method proceeds to steps 330 and 332 where one or more tactile pulses and visual pulses are generated. The method returns to step 302 after the generation of the tactile and/or visual pulses.

In operation, a musician or other suitable user is provided with a synchronization signal in a non-aural manner to enable the musician to synchronize with the signal without requiring the musician to focus on a sound signal.

In this manner, a musician or other suitable user may be synchronized with music or other suitable activities, including but limited to sporting activities (such as to begin a race), manufacturing activities (such as to start work on a manufacturing piece in a production line), cutting activities (such as cutting with a power saw), drilling activities (such as drilling with a power drill), hammering activities (such as striking a target), shooting activities (such as firing on a target), blasting activities (such as activating explosives), and construction activities (such as operating power machinery). The present invention thus lends itself to diverse applications, such as applications in which aural signals may be unavailable or unreliable.

Although several embodiments of the present invention and its advantages have been described in detail, it should be understood that changes, substitutions, transformations, modifications, variations, and alterations may be made therein without departing from the teachings of the present invention, the spirit and the scope of the invention being set forth by the appended claims.

What is claimed is:

1. An apparatus for providing a synchronized timing signal comprising:
a tactile stimulus system operable to generate a tactile stimulus in response to a driver signal;
a conversion system operable to receive a data signal that includes timing data and to generate a timing signal that is synchronized with the timing data;
a driver system coupled to the tactile stimulus system and the conversion system, the driver system operable to receive the timing signal and to generate the driver signal; and
wherein the driver signal is synchronized with the timing data.

2. The apparatus of claim 1 wherein the tactile stimulus system further comprises:
a seating apparatus configured to support a human being; and
a solenoid coupled to the seating apparatus, the solenoid configured to deliver a physical impulse to the seating apparatus such that the physical impulse will be imparted to the human being supported by the seat.

3. The apparatus of claim 2 wherein the driver system is a solenoid driver system.

4. The apparatus of claim 1 wherein the tactile stimulus system further comprises:
a seating apparatus configured to support a human being; and
a hydraulic drive coupled to the seating apparatus, the solenoid configured to deliver a physical impulse to the seating apparatus such that the physical impulse will be imparted to the human being supported by the seat.

5. The apparatus of claim 1 wherein the driver system is a hydraulic driver system.

6. The apparatus of claim 1 wherein the tactile stimulus system further comprises:
a belt apparatus configured to be worn around a mid-section of a human being; and
a solenoid coupled to the belt apparatus, the solenoid configured to deliver a physical impulse to the belt apparatus such that the physical impulse will be imparted to the human being that is wearing the belt apparatus.

7. The apparatus of claim 1 wherein the tactile stimulus system further comprises:
a belt apparatus configured to be worn around an extremity of a human being; and
a solenoid coupled to the belt apparatus, the solenoid configured to deliver a physical impulse to the belt apparatus such that the physical impulse will be imparted to the human being that is wearing the belt apparatus.

8. The apparatus of claim 1 wherein the conversion system is configured to receive a signal that is compatible with a musical instrument digital interface.

9. The apparatus of claim 1 wherein the conversion system further comprises a controllable timing circuit that is operable to controllably generate the timing data in response to user-entered controls.

10. The apparatus of claim 1 wherein the conversion system is operable to receive a wireless signal that includes the timing data.

11. An apparatus for providing a synchronized timing signal comprising:
a visual stimulus system operable to generate a visual stimulus in response to a driver signal;
a conversion system operable to receive a data signal that includes timing data and to generate a timing signal that is synchronized with the timing data;
a driver system coupled to the tactile stimulus system and the conversion system, the driver system operable to receive the timing signal and to generate the driver signal; and
wherein the driver signal is synchronized with the timing data.

12. The apparatus of claim 11 wherein the visual stimulus system further comprises:
a hat configured to be worn on the head of a human being; and
one or more light emitting devices attached to the hat configured so as to be seen by the human being wearing the hat.

13. The apparatus of claim 11 wherein the driver system is a light emitting device driver system.

14. The apparatus of claim 11 wherein the visual stimulus system further comprises:
eyeglasses that are configured to be worn by a human being; and
one or more light emitting devices attached to the eyeglasses configured so as to be seen by the human being wearing the eyeglasses.

15. The apparatus of claim 11 wherein the driver system is a light emitting device driver system.

16. The apparatus of claim 11 wherein the conversion system is configured to receive a signal that is compatible with a musical instrument digital interface.

17. The apparatus of claim 11 wherein the conversion system further comprises a controllable timing circuit that is operable to controllably generate the timing data in response to user-entered controls.

18. The apparatus of claim 1 wherein the conversion system is operable to receive a wireless signal that includes the timing data.

19. A method for providing a synchronized timing signal comprising:
receiving a signal that includes timing data;
generating a driver signal that is synchronized with the timing data;
providing the driver signal to a tactile stimulus device; and
generating a tactile stimulus that is synchronized with the timing data.

20. The method of claim 19 wherein receiving a signal that includes timing data comprises receiving a musical instrument digital interface signal.
